(19) United States
(12) Patent Application Publication
(10) Pub. No.: US 2012/0124212 A1
(43) Pub. Date: May 17, 2012

(54) APPARATUS AND METHOD FOR PROCESSING MULTI-LAYER DATA

(75) Inventors: Dong-Myoung BAEK, Daejeon-si (KR); Kang-Il CHOI, Daejeon-si (KR); Bhum-Cheol LEE, Daejeon-si (KR); Jung-Hee LEE, Daejeon-si (KR); Sang-Yoon OH, Daejeon-si (KR); Seung-Woo LEE, Daejeon-si (KR); Young-Ho PARK, Daejeon-si (KR)

(73) Assignee: Electronics and Telecommunications Research Institute, Daejeon-si (KR)

(21) Appl. No.: 13/298,746

(22) Filed: Nov. 17, 2011

(30) Foreign Application Priority Data
Nov. 17, 2010 (KR) 10-2010-0114586

(51) Int. Cl. G06F 15/173

(52) U.S. Cl. 709/226

(57) ABSTRACT

A multi-layer data processing apparatus and method are provided. The multi-layer data processing apparatus includes a lower hierarchy processing unit configured to generate at least one lower hierarchy flow from input data using lower hierarchy information, and to allocate the generated lower hierarchy flows to a plurality of lower hierarchy processors to perform lower hierarchy processing in respect of the lower hierarchy flows in parallel; and a higher hierarchy processing unit configured to generate at least one higher hierarchy flow from data transmitted from the lower hierarchy processing unit using higher hierarchy information, and to allocate the generated higher hierarchy flows to a plurality of higher hierarchy processors to perform higher hierarchy processing in parallel in respect of the higher hierarchy flows.

### CROSS-REFERENCE TO RELATED APPLICATION(S)

This application claims the benefit under 35 U.S.C. §119(a) of Korean Patent Application No. 10-2010-0114586, filed on Nov. 17, 2010, in the Korean Intellectual Property Office, the entire disclosure of which is incorporated herein by reference for all purposes.

### BACKGROUND

1. Field

The following description relates to multi-layer data processing, and more particularly, to an apparatus and method for effectively processing multi-layer data based on flows.

2. Description of the Related Art

In multi-layer data processing, a multiprocessor is utilized to improve processing performance. Increase of overall processing speed of multiprocessor relates to a parallel processing rate. According to Amdahl's law, in a case of small parallel processing rate, the entire multiprocessor processing speed is not increased but saturated even when individual processors are increased in number. As known from Amdahl's law, to increase a parallel processing speed linearly, parallel processing portions should be substantially more than series procession portions.

More multiple processors are used to improve multi-layer data processing capabilities, and the order of data flow of paralleling processing should be maintained. In this regards, prior arts have been introduced to enhance processing capabilities while preserving the order of data flow by finely classifying and distinguishing input data flow and allocating the same flows to the same processor core. However, even when the order of flows is maintained, a multiprocessor with a single array has difficulties in processing multi-layered data having different properties because the processing capabilities are not easily increased scalably and it is hardly possible to combine processor arrays with different structures for use.

As another approach to process multi-layer data, a number of layers are grouped together, that is, 7 layers are grouped into two or three groups. For example, according to protocols of open system interconnection (OSI) 7 layer model, with respect to Layer 2 (data link layer), Layer 3 (network layer), and Layer 4 (transport layer), frames or packets are generally processed using designated hardware or network processors, and a critical issue involved with these layers is a processing capability. With respect to Layer 7 (application layer) which contains various service contents, a general processor is used to process data in a software manner, and a critical issue involved with Layer 7 is flexibility. Thus, in a case in which a common processor processes multi-layer data, processing efficiency may be degraded because the processing methods for Layer 2-4 and Layer 7 are discordant with each other.

### SUMMARY

The following description relates to an apparatus and method for processing multiple-layer data, which use a plurality of hierarchy processing units, each including a plurality of processors for parallel processing, in effort to achieve scalable increase in data processing capabilities.

In one general aspect, there is provided a multi-layer data processing apparatus comprising: a lower hierarchy processing unit configured to generate at least one lower hierarchy flow from input data using lower hierarchy information, and to allocate the generated lower hierarchy flows to a plurality of lower hierarchy processors to perform lower hierarchy processing in respect of the lower hierarchy flows in parallel; and a higher hierarchy processing unit configured to generate at least one higher hierarchy flow from data transmitted from the lower hierarchy processing unit using higher hierarchy information, and to allocate the generated higher hierarchy flows to a plurality of higher hierarchy processors to perform higher hierarchy processing in parallel in respect of the higher hierarchy flows.

In another genera aspect, there is provided a method of processing multi-layer data, the method comprising: generating at least one lower hierarchy flow from input data in a lower hierarchy processing unit using lower hierarchy information; allocating the lower hierarchy flow generated by the lower hierarchy processing unit to a plurality of lower hierarchy processors and performing lower hierarchy processing in parallel on the lower hierarchy flow; transmitting data to be processed at higher hierarchy, among the input data, to a higher hierarchy processing unit from the lower hierarchy processing unit; generating at least one higher hierarchy flow from the data transmitted from the lower hierarchy processing unit in the higher hierarchy processing unit using higher hierarchy information; and allocating the higher hierarchy flow generated by the higher hierarchy processing unit to a plurality of higher hierarchy processors and performing higher hierarchy processing in parallel on the higher hierarchy flow.

Other features and aspects may be apparent from the following detailed description, the drawings, and the claims.

### BRIEF DESCRIPTION OF THE DRAWINGS

FIG. 1 is a diagram illustrating an example of a flow-based multi-layer data processing apparatus.

FIG. 2 is a diagram illustrating an example of a multi-layer data processing apparatus of FIG. 1.

FIG. 3 is a diagram illustrating another example of a multi-layer data processing apparatus to process packet data.

FIG. 4 is a diagram illustrating an example of a common database of a multi-layer data processing apparatus shown in the example illustrated in FIG. 3.

FIG. 5 is a flowchart illustrating an example of a method of processing multi-layer data.

FIG. 6 is a flowchart illustrating another example of a method of processing multi-layer data.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

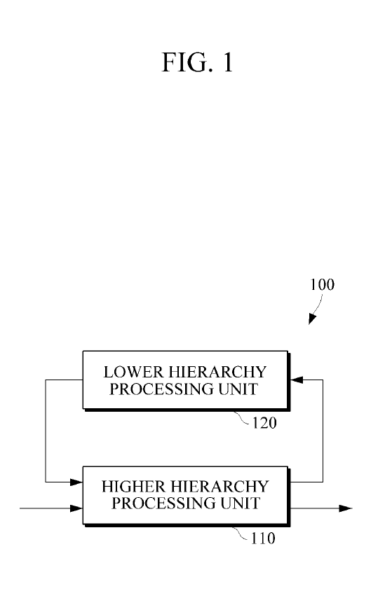

FIG. 1 illustrates an example of a flow-based multi-layer data processing apparatus.

The multi-layer data processing apparatus 100 may include a lower hierarchy processing unit 110 and a higher hierarchy processing unit 120 to process data having multi-layer structure in an integrated manner. The data having multi-layer structure may not be limited to only one type of data having hierarchical structure. For example, the multi-layer data may be packet data which is classified into L2 to L7 layers.

The lower hierarchy processing unit 110 may receive data input from the outside, perform lower-layer process on the input data and output the processed data. In addition, the lower hierarchy processing unit 110 may output data input from the outside to the higher hierarchy processing unit 120. The higher hierarchy processing unit 120 may receive the data output from the lower hierarchy processing unit 110, perform higher-layer process on the received data and output the processed data to the lower hierarchy processing unit 110.

The lower hierarchy processing unit 110 may generate at least one lower hierarchy flow from data input from the outside and data input from the higher hierarchy processing unit 120 using lower hierarchy information, and execute functions in parallel which are allocated to lower layers according to the generated flows. The lower hierarchy processing unit 110 may allocate the generated flows to processors or threads and process them in parallel.

In this case, a flow refers to a group of packets having the same properties. A lower hierarchy flow may refer to a group of data to be processed by the same processor because the data have at least one common property in respect of data input from the outside.

The lower hierarchy processing unit 110 may be connected to the higher hierarchy processing unit 120, output flows to be processed by the higher hierarchy processing unit 120, and re-process the data which has been processed by the higher hierarchy processing unit 120 in association with the higher hierarchy processing unit 120.

The higher hierarchy processing unit 120 may generate a higher hierarchy flow using higher hierarchy information, and execute functions in parallel which are allocated to higher layers according to the generated flows. The higher hierarchy information may include classification criteria for the higher hierarchy flows. The higher hierarchy flow may include at least one common property in respect of data transmitted from the lower hierarchy processing unit 110, and thus it may refer to data to be processed by the same processor or a unit of task to be processed by one processor or one thread.

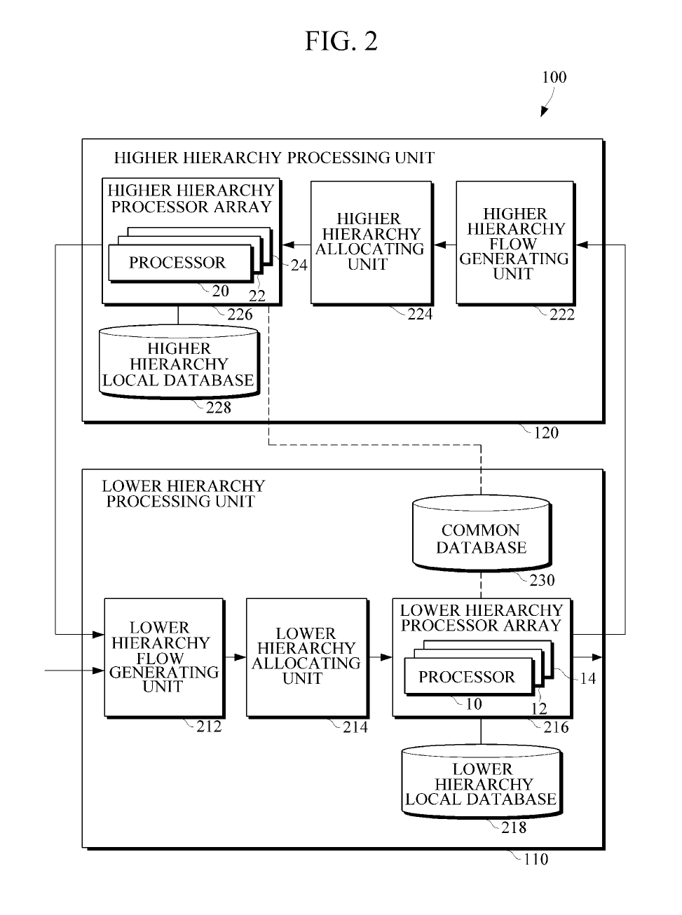

FIG. 2 illustrates an example of a multi-layer data processing apparatus of FIG. 1.

The multi-layer data processing apparatus 100 may include a lower hierarchy processing unit 110 and a higher hierarchy processing unit 120.

The lower hierarchy processing unit 110 may include a lower hierarchy flow generating unit 212, a lower hierarchy allocating unit 214, a lower hierarchy processor array 216, a lower hierarchy local database 218, and a common database 230.

The lower hierarchy flow generating unit 212 may receive data input from the outside and generate at least one lower hierarchy flow from the input data using lower hierarchy information. Alternatively, the lower hierarchy flow generating unit 212 may generate a lower hierarchy flow from received data input from the higher hierarchy processing unit 120, which will be described later, using lower hierarchy information.

The lower hierarchy allocating unit 214 may be connected to the lower hierarchy flow generating unit 212 and allocate lower hierarchy flows to multiple processors 10, 12, and 14 of a lower hierarchy processor array 216, which will be described later, on a generated flow basis. For example, the lower hierarchy allocating unit 214 may allocate pieces of data which are identified to be the same flow to the same processor, for example, the processor 10 for processing.

The lower hierarchy processor array 216 may include multiple processors or cores inside a multi-core processor. The lower hierarchy processor array 216 may be connected to the lower hierarchy allocating unit 214 to process the flows distributed by the lower hierarchy allocating unit 214 and output processed data to the outside. As another example, the lower hierarchy processor array 216 may output the processed data to the higher hierarchy processing unit 120 which will be described later. For example, the processor 10 of the lower hierarchy processor array 216 may transmit processed data to the higher hierarchy processing unit 120 in a case where the common database 230 has higher hierarchy rule set and action information which correspond to lower hierarchy rule set and action information to be applied to a given flow. As another example, the processor 10 of the lower hierarchy processor 216 may determine whether to perform higher-hierarchy processing on the lower hierarchy flow based on predefined conditions, such as the occurrence of abnormal properties in the processed lower hierarchy flow, and, for example, the occurrence of abnormal pattern in status information of the lower hierarchy flow.

The lower hierarchy processor array 216 may refer to its connected lower hierarchy local database 218, and process allocated data. In the example illustrated in FIG. 2, the lower hierarchy processor array 216 includes three processors 10, 12, and 14, but the type and number of processors to be included in the lower hierarchy processor array 216 is not limited thereto.

The lower hierarchy local database 218 may store a rule set and action information to be applied to each lower hierarchy flow in the form of table. The lower hierarchy local database 218 may store a key value of each lower hierarchy flow, for example, hash value. Thus, in response to inputting a given flow, a hash value of the input flow is used to search for a rule set and actions which are to be applied to the input flow.

In the example illustrated in FIG. 2, the lower hierarchy local database 218 is connected to the lower hierarchy processor array 216, but the lower hierarchy local database 218 may be implemented in each processor belonging to the lower hierarchy processor array 216.

The common database 230 may be logically or physically connected to the lower hierarchy processor array 216 and the higher hierarchy processor array 226, and thus may be shared by the lower hierarchy processing unit 110 and the higher hierarchy processing unit 120. In addition, the common database 230 may be operated in association with each of the lower hierarchy processing unit 110 and the higher hierarchy processing unit 120. The common database 230 may store rule set and action information to be applied to a higher hierarchy flow corresponding to rule set and action information to be applied to the lower hierarchy flow.

For example, the processor 20 of the higher hierarchy processing unit 120 may change rule set and action information in the common database 230 which are to be used by the lower hierarchy processing unit 110 for processing data which is determined to be processed by the lower hierarchy processing unit 110. Accordingly, the lower hierarchy processing unit 110 may enable to process data using the changed rule set and action information.

The higher hierarchy processing unit 120 may include a higher hierarchy flow generating unit 222, a higher hierarchy allocating unit 224, a higher hierarchy processor array 226, and a higher hierarchy local database 228.

The higher hierarchy flow generating unit 222 may receive data input from the lower hierarchy processing unit 110, and generate a higher hierarchy flow by applying higher hierarchy information to the received data. The higher hierarchy flow generating unit 222 may generate a higher hierarchy flow in respect of data transmitted from the lower hierarchy processing unit 110 or a lower hierarchy flow using given criteria optimized to properties of data to be processed at a higher hierarchy level.

The higher hierarchy allocating unit 224 may be connected to the higher hierarchy flow generating unit 222 and allocate flows to multiple processors of the higher hierarchy processor array 226 or threads on a generated flow basis.

Like the lower hierarchy processor array 216, the higher hierarchy processor array 226 may include a plurality of processors 20, 22, and 24 inside a multi-core processor. The higher hierarchy processor array 226 may be connected to the higher hierarchy allocating unit 224, process the flow allocated by the higher hierarchy allocating unit 224 and output the processed flow to the lower hierarchy processing unit 110.

Each of the processors 20, 22, and 24 of the higher hierarchy processor array 226 may refer to the higher hierarchy local database 228 connected to the higher hierarchy processor array 226 to process the allocated data. The higher hierarchy local database 228 may store rule set and action information to be applied to each higher hierarchy flow in the form of table. In the example illustrated in FIG. 2, the higher hierarchy local database 228 is connected to the higher hierarchy processor array 226, but the higher hierarchy local database 228 may be implemented in each of the processors 20, 22, and 24 belonging to the higher hierarchy processor array 226.

Also, in the example illustrated in FIG. 2, the common database 230 is included in the lower hierarchy processing unit 110, it may be included in the higher hierarchy processing unit 120, or outside of the lower hierarchy processing unit 110 and the higher hierarchy processing unit 120. Each of the lower hierarchy local database 128, the higher hierarchy local database 228, and the common database 230 may be configured such that a network administrator can access via an external interface and change rule set and action information with respect to classified flows.

In addition, although in the example illustrated in FIG. 2 the apparatus 100 includes two hierarchy processing units, the lower hierarchy processing unit 110 and the higher hierarchy processing unit 120, the apparatus 100 may include three or more hierarchy processing units. Furthermore, in this case, each of the hierarchy processing units may generate at least one flow in respect of data, and allocate the generated flows to multiple processors belonging to each hierarchy processing unit to process the flows in parallel. The multi-layer data processing apparatus 100 may be implemented in various types of personal computers (PCs), electronic appliances, communication devices connected to a network, or the like.

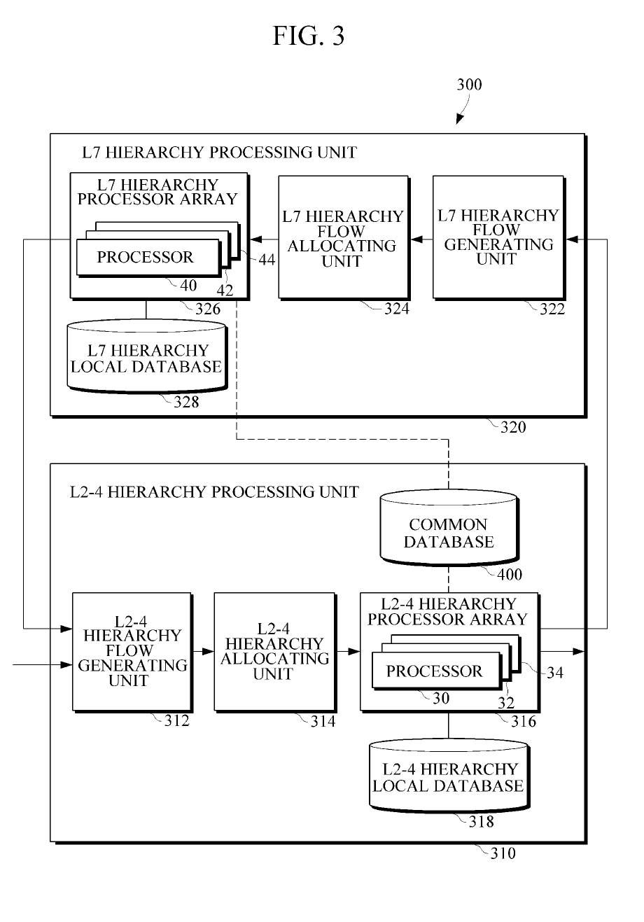

FIG. 3 illustrates another example of a multi-layer data processing apparatus to process packet data.

The multi-layer data processing apparatus 300 which processes a multi-layer IP packet may include an L2-4 hierarchy processing unit 310 and an L7 hierarchy processing unit 320. The L2-4 hierarchy processing unit 310 may generate an L2-4 hierarchy flow in respect of a packet input through a network by use of information of layer 2 to layer 4, and process the generated L2-4 flow in parallel. The L7 hierarchy processing unit 320 may generate an L7 hierarchy flow using information about Layer 7 of a packet input from the L2-4 hierarchy processing unit 310 and process the generated L7 hierarchy flow in parallel.

The L2-4 hierarchy processing unit 310 may include an L2-4 hierarchy flow generating unit 312, an L2-4 hierarchy allocating unit 314, an L2-4 hierarchy processor array 316, an L2-4 hierarchy local database 318, and a common database 400. The L7 hierarchy processing unit 320 may include an L7 hierarchy flow generating unit 322, an L7 hierarchy flow allocating unit 324, an L7 hierarchy processor array 326, and an L7 hierarchy local database 328.

In this case, each of the L2-4 hierarchy processor array 316 and the L7 hierarchy processor array 326 may include multiple processors. Processors or threads are assigned to the L2-4 hierarchy processor array 316 and the L7 hierarchy processor array 326 in units of flow in an effort to increase parallel processing capabilities for improving multi-layer data processing performance. The processors 30, 32, and 34 belonging to the L2-4 hierarchy processor array 316 may process an L2-4 hierarchy flow in respect of an input IP packet, and the processors 40, 42, and 44 belonging to the L7 hierarchy processor array 326 may process an L7 hierarchy flow.

The L2-4 hierarchy flow generating unit 312 may perform shallow classification on an input IP packet. According to shallow classification, a key value of a lower hierarchy is generated using packet classification rules and L2-4 hierarchy information included in a packet header of the input IP packet, and a flow is generated based on the IP packet which is classified according to the generated key value. The key value of the classified packet may be a hash value that is generated using L2-4 hierarchy information included in a header of the input packet. The L2-4 hierarchy information may include a source IP address, a destination IP address, a source port, a destination port, and a protocol ID. The L2-4 hierarchy flow generating unit 312 may classify packets having at least one same property among a source IP address, a destination IP address, a source port, a destination port, and a protocol ID as the same flow.

The L2-4 hierarchy flow generating unit 312 may manage classified IP packets, that is, a state of each flow (creation, change, disappearance) or flow traffic state (increase, decrease, or the like). Information about the state of the flow or the flow traffic state may be stored and managed in the L2-4 hierarchy local database 318.

The L2-4 hierarchy allocating unit 314 may distribute or allocate L2-4 hierarchy flow according to policies of the multiple processors 30, 32, and 34 belonging to the L2-4 hierarchy processor array 316. For example, the L2-4 hierarchy allocating unit 314 may use policies according to which the same flow is allocated to the same processor of the L2-4 hierarchy processor array 316, for example, to the processor 30.

The L2-4 hierarchy processor array 316 may include multiple processors or cores. Each processor 30, 32, and 34 of the L2-4 hierarchy processor array 316 may process a packet through at least one thread. In this case, an algorithm for determining a flow and a core or a thread to which the flow is allocated may follow the policies of the L2-4 hierarchy allocating unit 314 described above.

The L2-4 hierarchy processor array 316 may refer to the rule set and action information of the L2-4 hierarchy local database 318 and the common database 400 to process the L2-4 hierarchy flow. For example, the L2-4 hierarchy processor array 316 may deny or discard classified packet, transmit the classified packet to an original designated network, or intercept packets to transmit it to the L7 hierarchy processing unit 320 using the information of the L2-4 hierarchy local database 318.

The L2-4 hierarchy local database 318 may store the rule set and action information to be applied to each L2-4 hierarchy flow in the form of table. Although in the example illustrated in FIG. 3, the L2-4 hierarchy local database 318 is connected to the lower hierarchy processor array 316, the L2-4 hierarchy local database 318 may be provided to be individually connected to each processor belonging to the lower hierarchy processor array 316.

The L7 hierarchy flow generating unit 322 may classify the packet received from the L2-4 hierarchy processor array 316 by generating a key value for a classified packet using L7 hierarchy information and classification rule set, generate at least one L7 hierarchy flow, and manage the state of the L7 hierarchy flow. For example, the L7 hierarchy information may include data contained in a payload of a packet. Thus, the L7 hierarchy flow may be generated by classifying the L2-4 hierarchy flow which is generated according to the L2-4 hierarchy information, based on contents of a payload of the packet.

The L7 hierarchy allocating unit 324 may allocate the L7 hierarchy flows to multiple processors 40, 42, and 44 belonging to the L7 hierarchy processor array 326 according to policies. In this case, the L7 hierarchy allocating unit 324 may use a policy according to which the same L7 flow is allocated to the same processor of the L7 hierarchy processor array 326, for example, the processor 40.

The L7 hierarchy processor array 326 may include multiple processors or cores. Each processor of the L7 hierarchy processor array 326 may process a packet through one or more threads. An algorithm for determining a flow and a core or a thread to which the flow is allocated may follow the policies of the L7 hierarchy allocating unit 324.

The L7 hierarchy local database 328 may store rule set and action information to be applied to each flow of the L7 hierarchy in the form of table. Although in the example illustrated in FIG. 3, the L7 hierarchy local database 328 is connected to the L7 hierarchy processor array 326, the L7 hierarchy local database 328 may be provided to be individually connected to each processor belonging to the lower hierarchy processor array 326.

The common database 400 may include a table of rule set and action information which can be accessed in common by the L2-4 hierarchy processing unit 310 and the L7 hierarchy processing unit 320. Unlike the L2-4 hierarchy local database 318 and the L7 hierarchy local database 328, the common database 400 may be commonly used by the L2-4 hierarchy processing unit 310 and the L7 hierarchy processing unit 320 which are associated therewith.

In a case in which according to a result of analyzing a payload of a packet received from the L7 hierarchy processing unit 320 the packet is determined to be processed by the L2-4 hierarchy processing unit 310, the L7 hierarchy processing unit 320 may return a packet received from the L2-4 hierarchy processing unit 310 to the L2-4 hierarchy processing unit 310, and adjust the L2-4 hierarchy-based rule set and action information in the common database 400 such that the L2-4 hierarchy processing unit 310 can process the packet. Accordingly, the L2-4 hierarchy processing unit 310 may read the adjusted L2-4 hierarchy-based rule set and action information from the common database 400 and process the packet returned from the L7 hierarchy processing unit 320.

The multi-layer data processing apparatus 300 may be implemented in a router, a bridge, a personal computer, a workstation connected to a network, or the like. The multi-layer data processing apparatus 300 may enable data formed by full layers from layer 1 to layer 7 (or some layers) to be simultaneously processed in parallel.

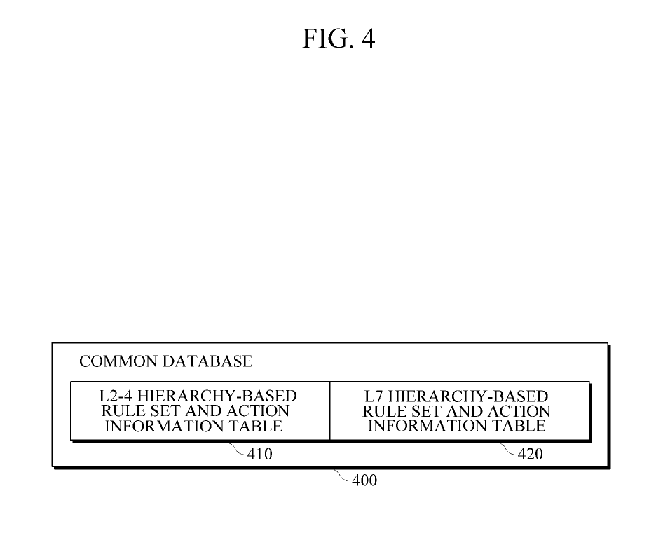

FIG. 4 illustrates an example of a common database of a multi-layer data processing apparatus shown in the example illustrated in FIG. 3.

The common database 400 may include an L2-4 hierarchy-based rule set and action information table 410 for H2-4 hierarchy processing and an L7 hierarchy-based rule set and action information table 420.

The common database 400 may have each row of the L2-4 hierarchy-based rule set and action information table 410 corresponding to each row of the L7 hierarchy-based rule set and action information table 420 which is used at an L7 hierarchy. For example, rule set and action information of the L2-4 hierarchy-based rule set and action information table 410 may correspond to rule set and action information of the L7 hierarchy-based rule and action information table 420 one-to-one or one-to-n (n is a natural number). The L2-4 hierarchy-based rule set and action information table 410 and the L7 hierarchy-based rule set and action information table 420 may be formed to correspond to each other using hash values of L2-4 hierarchy flows.

Under the assumption that the L2-4 hierarchy-based rule set and action information table 410 one-to-one corresponds to the L7 hierarchy-based rule set and action information table 420, a case in which only L2-4 hierarchy processing is required for a L2-4 hierarchy flow may indicate that the L2-4 hierarchy-based rule set and action information table 410 includes rule set and action information, but not L7 hierarchy-based rule set and action information. In a case where the L2-4 hierarchy-based rule set and action information and the L7 hierarchy-based rule set and action information correspond to each other, the L2-4 hierarchy flow undergoes the L2-4 hierarchy processing and then L7 hierarchy processing, and the processed flow is output. The L2-4 hierarchy-based rule set and action information may be changed through the L7 hierarchy processing by returning a packet transmitted to L7 hierarchy to the L2-4 hierarchy processing unit 310 according to determination of the L7 hierarchy processing unit 320 to perform lower hierarchy processing.

In addition, the common database 400 may be formed to be intelligently updated by combining states (creation, change, and disappearance) of flows generated at L2-4 hierarchy and L7 hierarchy, flow traffic states (increase, decrease, and the like) and policies.

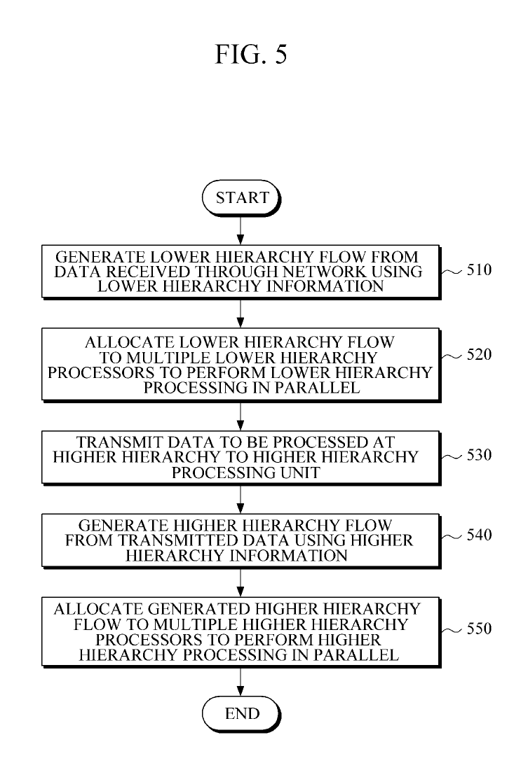

FIG. 5 illustrates a flowchart of an example of a method of processing multi-layer data.

Referring to FIGS. 2 and 5, the lower hierarchy processing unit 110 generates a lower hierarchy flow by applying lower hierarchy information to data input through a network (510).

The lower hierarchy processing unit 110 may allocate the generated lower hierarchy flows to multiple lower hierarchy processors to perform lower hierarchy processing on the lower hierarchy flows in parallel (520).

The lower hierarchy processing unit 110 transmits data to be processed at higher hierarchy among those received by the lower hierarchy processing unit 110 to the higher hierarchy processing unit 120 (530).

The higher hierarchy processing unit 120 generates a higher hierarchy flow from the received data using higher hierarchy information (540).

The higher hierarchy processing unit 120 generates the higher hierarchy flow and allocates the generated higher hierarchy flow to multiple higher hierarchy processors and the multiple higher hierarchy processors perform higher hierarchy processing on the allocated flow in parallel (550).

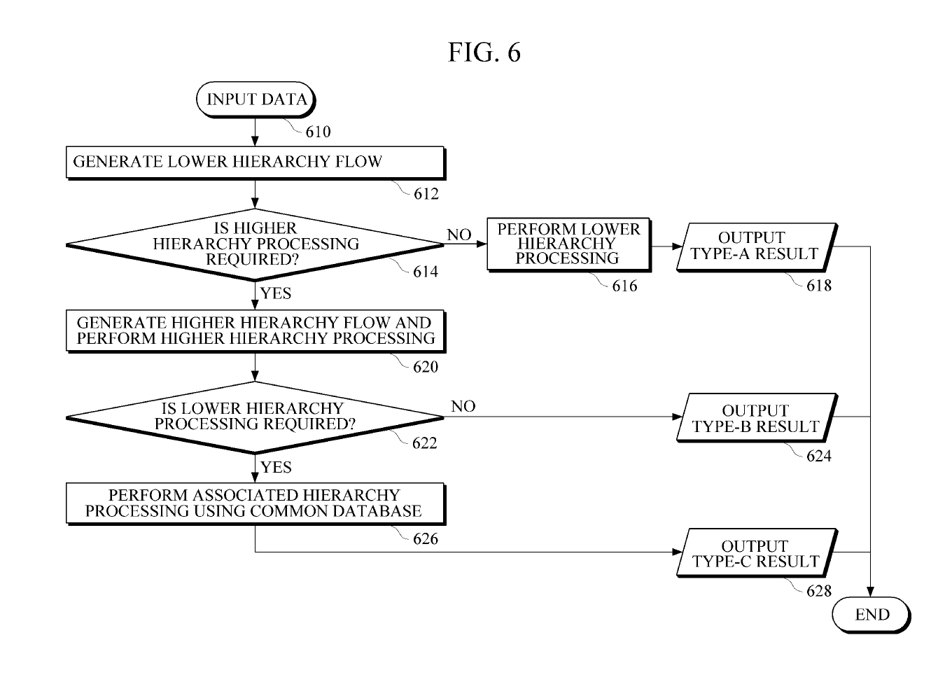

FIG. 6 illustrates a flowchart of another example of a method of processing multi-layer data.

Referring to FIGS. 2 and 6, in response to data input (610), the lower hierarchy flow generating unit 112 generates at least one lower hierarchy flow using lower hierarchy s information of the input data (612).

The lower hierarchy allocating unit 214 verifies the generated lower hierarchy flow to determine whether higher hierarchy processing is required in units of flow (614). If the higher hierarchy processing is not required, the generated lower hierarchy flow is allocated to one processor or thread of the lower hierarchy processor array 216 according to scheduling policies of the lower hierarchy allocating unit 214, then the allocated lower hierarchy flow is processed in parallel (614), and an A-type result is output (616). Here, the A-type result is obtained by only performing lower hierarchy processing. Determination whether the higher hierarchy processing is required or not may be performed by the lower hierarchy processor array 216, and operations 614 and 616 may be switched therebetween. As described above, in a case where the lower hierarchy flow only requires the lower hierarchy processing, the flow processing is completed by lower hierarchy processing on the input data.

In response to the lower hierarchy allocating unit 214 determining that higher hierarchy processing is required for the generated lower hierarchy flow (614), the processor array 216 transmits data determined to be analyzed along with generated flow information to the higher hierarchy processing unit 120. The higher hierarchy flow generating unit 222 of the higher hierarchy processing unit 120 generates a higher hierarchy flow, and the higher hierarchy allocating unit 224 allocates the generated flow to the higher hierarchy processor array 226 to perform higher hierarchy processing on the flow in parallel (620).

Meanwhile, the higher hierarchy processor array 226 verifies the lower hierarchy flow which has undergone the higher hierarchy processing at higher hierarchy and analyzes if the lower hierarchy processing is required (622). If the lower hierarchy processing is not required (622), the higher hierarchy processing unit 220 outputs a type B result that outputs the higher hierarchy processing result executed in operation 620 (624). In a case in which the higher hierarchy processing performed (620) after the lower hierarchy processing has been performed (616), the type B result may include lower hierarchy processing result and higher hierarchy processing result.

The analysis result indicates that the lower hierarchy processing is required (622), the higher hierarchy processor array 226 sends the lower hierarchy flow information and the higher hierarchy flow processing result to the lower hierarchy processing unit 110, and performs associated hierarchy processing using the common database 230 (626). In the associated hierarchy processing using the common database 230, as described above, lower hierarchy rule set and action information for a flow is changed by the higher hierarchy processor array 226 and the data transmitted from the higher hierarchy processor 226 is processed using lower hierarchy rule set and action information which has been changed by the lower hierarchy processor array 216. Thereafter, the lower hierarchy processor array 216 outputs a type-C result that includes the associated hierarchy processing result (628). As such, when it is determined that the lower hierarchy processing is required, the higher hierarchy processing unit 120 does not perform the lower hierarchy processing by itself, but makes the lower hierarchy processing unit 110 perform the lower hierarchy processing using the common database 230, thereby increasing parallel processing efficiency.

As such, data having a multi-layer structure is parallel-processed hierarchically, and flows are generated at higher and lower hierarchies and allocated to individual cores or threads of a multiprocessor, so that the parallel processing rate can be increased. Additionally, hierarchies are classified based on properties, and processed according to the classification result, thereby overcoming locality issues of the parallel processing.

Furthermore, the processors may be configured to be grouped together according to functionalities and capabilities at the higher and lower hierarchies. As such, the functionalities and capabilities are computed hierarchically, and thus electricity consumption can be easily controlled. Moreover, a multi-core processor may be formed of two or more layers with two or more chips which are associated with each other, and thus may result in the same effect as a multi-core processor which is implemented with a single chip.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-layer data processing apparatus comprising:
a lower hierarchy processing unit configured to generate at least one lower hierarchy flow from input data using lower hierarchy information, and to allocate the generated lower hierarchy flows to a plurality of lower hierarchy processors to perform lower hierarchy processing in respect of the lower hierarchy flows in parallel; and
a higher hierarchy processing unit configured to generate at least one higher hierarchy flow from data transmitted from the lower hierarchy processing unit using higher hierarchy information, and to allocate the generated higher hierarchy flows to a plurality of higher hierarchy processors to perform higher hierarchy processing in parallel in respect of the higher hierarchy flows.

2. The multi-layer data processing apparatus of claim 1, wherein the lower hierarchy processing unit is configured to comprise
a lower hierarchy flow generating unit configured to generate at least one lower hierarchy flow from the received data using the lower hierarchy information,
a lower hierarchy allocating unit configured to allocate the at least one lower hierarchy flow to individual processors for processing, and
a plurality of the processors, each configured to process the flow allocated by the lower hierarchy allocating unit on a flow basis.

3. The multi-layer data processing apparatus of claim 1, wherein the higher hierarchy processing unit is further configured to comprise
a higher hierarchy flow generating unit configured to generate the at least one higher hierarchy flow from the data received from the lower hierarchy processing unit using the higher hierarchy information,
a higher hierarchy allocating unit configured to allocate the at least one higher hierarchy flow to individual processors for processing, and
a plurality of the processors, each configured to process the flow allocated by the higher hierarchy allocating unit on a flow basis.

4. The multi-layer data processing apparatus of claim 1, further comprising:
a common database configured to be connected to the lower hierarchy processing unit and the higher hierarchy processing unit for common use, and to store rule set and action information to be used by the lower hierarchy processing unit and the higher hierarchy processing unit.

5. The multi-layer data processing apparatus of claim 4, wherein the common database is configured to store such that rule set and action information to be applied to the lower hierarchy flow and rule set and action information to be applied to the higher hierarchy flow correspond to each other.

6. The multi-layer data processing apparatus of claim 4, wherein, when the data which is received from the lower hierarchy processing unit has been determined to be processed by the lower hierarchy processing unit,
the higher hierarchy processing unit changes lower hierarchy rule set and action information for the data in the common database and transmit the data to the lower hierarchy processing unit, and
the lower hierarchy processing unit processes the data transmitted from the higher hierarchy processing unit using the changed lower hierarchy rule set and information in the common database.

7. The multi-layer data processing apparatus of claim 1, wherein the lower hierarchy processing unit is further configured to perform L2 to L4 hierarchy processing on an input packet, and the higher hierarchy processing unit is further configured to perform L7 hierarchy processing on an input packet.

8. The multi-layer data processing apparatus of claim 7, wherein if the data is an internet protocol (IP) packet, the lower hierarchy information includes a source IP address, a destination IP address, a source port, a destination port, and a protocol ID.

9. A method of processing multi-layer data, the method comprising:
generating at least one lower hierarchy flow from input data in a lower hierarchy processing unit using lower hierarchy information;
allocating the lower hierarchy flow generated by the lower hierarchy processing unit to a plurality of lower hierarchy processors and performing lower hierarchy processing in parallel on the lower hierarchy flow;
transmitting data to be processed at higher hierarchy, among the input data, to a higher hierarchy processing unit from the lower hierarchy processing unit;
generating at least one higher hierarchy flow from the data transmitted from the lower hierarchy processing unit in the higher hierarchy processing unit using higher hierarchy information; and
allocating the higher hierarchy flow generated by the higher hierarchy processing unit to a plurality of higher hierarchy processors and performing higher hierarchy processing in parallel on the higher hierarchy flow.

10. The method of claim 9, further comprising:
processing data using a common database configured to be connected to the lower hierarchy processing unit and the higher hierarchy processing unit for common use, and to store rule set and action information to be used by the lower hierarchy processing unit and the higher hierarchy processing unit.

11. The method of claim 10, further comprising:
when the data which is received from the lower hierarchy processing unit has been determined to be processed by the lower hierarchy processing unit,
changing, at the higher hierarchy processing unit, lower hierarchy rule set and action information for the received data in the common database;
transmitting the received data from the higher hierarchy processing unit to the lower hierarchy processing unit; and
processing, at the lower hierarchy processing unit, the data transmitted from the higher hierarchy processing unit using the changed lower hierarchy rule set and information which is read from the common database.
